(19) United States
(12) Patent Application Publication
(10) Pub. No.: US 2014/0077500 A1
(43) Pub. Date: Mar. 20, 2014

(54) Gravity-assisted oscillating-wing power generator with flow-induced pitch-plunge phasing

(71) Applicants: Maximilian F. Platzer, Pebble Beach, CA (US); Nesrin Sarigul-Klijn, Dixon, CA (US)

(72) Inventors: Maximilian F. Platzer, Pebble Beach, CA (US); Nesrin Sarigul-Klijn, Dixon, CA (US)

(21) Appl. No.: 13/987,943

(22) Filed: Sep. 24, 2011

Related U.S. Application Data
(60) Provisional application No. 61/404,132, filed on Sep. 27, 2010.

(51) Int. Cl. H02K 7/18

(52) U.S. Cl. CPC H02K 7/1892
USPC 290/54

(57) ABSTRACT

A new method for converting the kinetic energy of wind and water flows into electric energy, comprising oscillating-wing power generators with vertical wings or blades mounted on essentially horizontal wings that are attached elastically to a rigid surface so that the essentially horizontal wings can be excited into flapping oscillations by means of a suitable mechanism.

### BACKGROUND OF THE INVENTION

1. Field of the Invention

This invention relates in general to wings and blades, and in particular to wings and blades which oscillate in such a way that they convert the energy of flowing air or water into electrical energy.

2. Discussion of the Related Art

The phenomenon of wing flutter is well known to aeronautical engineers, whereby an aircraft wing may experience catastrophic failure in a few seconds due to the fact that the wing may absorb energy from the air flow. This type of flutter usually requires that the wing is free to oscillate in at least two degrees of freedom, say in bending and torsion. It follows that if an airfoil is mechanically coupled in pitch and plunge it can extract energy from the flow. It is feasible to construct an oscillating wing power generator for the purpose of extracting useful power from a flow. In 1981, McKinney and DeLaurier built such a device at the University of Toronto which they described in the Journal of Energy, Vol. 5, No. 2, pp. 109-115, “The Wingmill: An Oscillating-Wing Windmill”. It consists of a horizontally mounted wing whose plunging motion is transformed into a rotary shaft motion. The wing is pivoted to pitch at its half-chord location by means of a fitting which is rigidly attached to the vertical support shaft. Also fixed to the support shaft is the outer sleeve of a push-pull cable whose end pivots on a wing-fixed lever to control the wing's pitch. The up-and-down motion of the support shaft is transformed, through a Scotch-yoke mechanism, into a rotary motion of a horizontal shaft. This shaft, in turn, operates a crank at its far end which actuates the previously mentioned pitch-control cable. Hence the wing's pitching and plunging motions are articulated together at a given frequency and phase angle. Wind tunnel tests of this device showed that this type of power generator is capable of converting wind energy into electricity with an efficiency approaching that of conventional windmills. In recent years, K. D. Jones, S. T. Davids, M. F. Platzer and K. D. Jones, K. Lindsey, M. F. Platzer built similar wingmills for use in water flows which they described in the Proceedings of the 3^{rd} ASME/JSME Joint Fluids Engineering Conference, San Francisco, July 1999 and in the Proceedings of the Second International Conference on Fluid Structure Interaction II, WIT Press 2003, pp. 73-82, respectively. They showed that this type of power generator is capable of converting water flow energy into electricity. Furthermore, the company Engineering Business Ltd in Riding Mill, Northumberland, England, built an oscillating-wing hydropower generator, called “Stingray”, which demonstrated an output of 150 kW.

These prior art oscillating-wing power generators have the disadvantage of requiring a rather elaborate mechanism to enforce the wing's pitch-plunge motion at the proper phase angle between the pitch and plunge motions. For this reason, Platzer and Bradley developed an oscillating-wing power generator which requires no elaborate mechanism to enforce the wing's pitch-plunge motion at the proper phase angle between the pitch and plunge motions. This novel generator was described in their patent application Ser. No. 12/266,553 dated Nov. 7, 2008.

### SUMMARY OF THE INVENTION

The present invention retains the novel power generator described in the patent application Ser. No. 12/266,553, but adds an additional mechanism to improve the generator performance. In summary, the essence of the proposed oscillating-wing power generator is the placement of the power generator on wings that can be excited into flapping oscillations thus exposing the generator wings or blades to a gravity component which enhances the generator wing or blade oscillation if properly phased by the oscillation of wing-mounted control surfaces or other suitable oscillation exciters.

### BRIEF DESCRIPTION OF THE DRAWINGS

FIG. 1 depicts the placement of two oscillating-wing power generators of the type disclosed in patent application Ser. No. 12/266,533 on the wings of an aircraft. It is the basic configuration which is modified in FIGS. 2 through 8 to demonstrate the performance enhancing mechanism disclosed in the present invention.

FIGS. 2 and 3 depict the essence of the present invention. The power generator is mounted on a wing which is flexibly attached to a body, thus making it possible to deflect the wing upward (as in FIG. 2) or downward (as in FIG. 3). The body is shown without a horizontal tail to indicate that the body may be attached to a ground-based structure, but with a vertical tail to indicate that the body will always align itself with the prevailing wind direction.

FIGS. 4 and 5 depict the same configuration, but with a left and right wing and left and right power generators. Only the upward deflected wing configuration is shown.

FIGS. 6 and 7 depict the single wing of FIGS. 2 and 3, but the body is equipped with a horizontal tail.

FIG. 8 depicts the complete aircraft configuration with two wings and two power generators and with horizontal and vertical tail surfaces, thus making it suitable for tethered free flight.

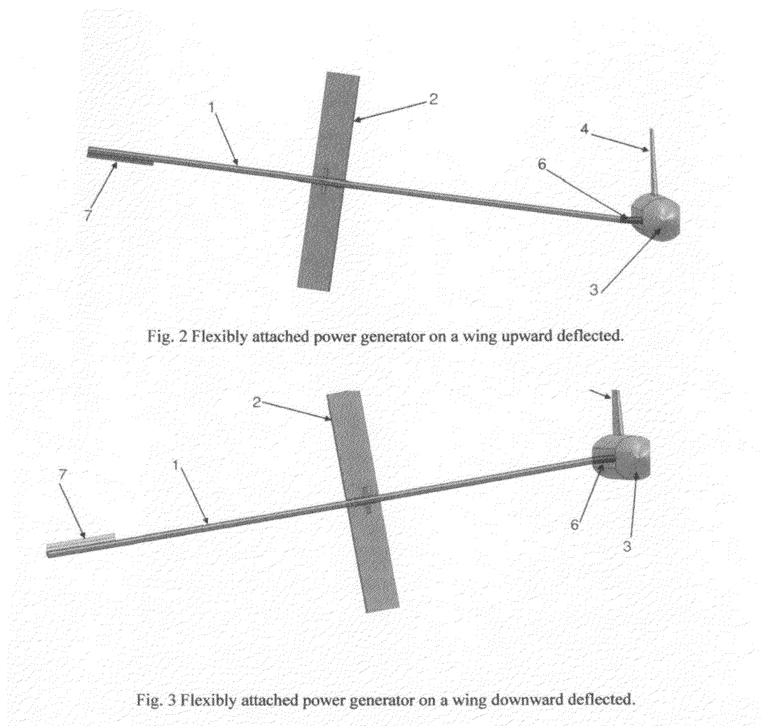

Note the presence of control surfaces near the wing tips and of elastic connectors connecting the wings to the body in FIGS. 2 through 8. Oscillation of the control surfaces excites the wings into flapping oscillations which, if properly phased, enhance the oscillatory motion of the power generator wings.

### DETAILED DESCRIPTION OF THE INVENTION

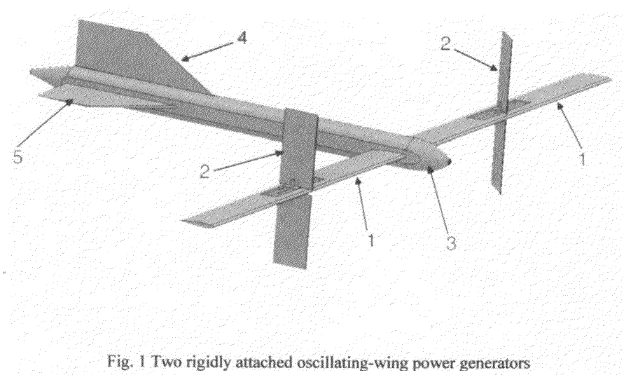

The essence of the proposed new power generator can be understood from FIGS. 1 through 8. FIG. 1 depicts an aircraft with two horizontal rectangular wings 1. A vertical power generator 2 is embedded in each wing. The characteristics and functioning of the type of oscillating-wing power generator shown in FIG. 1 was described in the previous patent application Ser. No. 12/266,533 and therefore is not described in further detail in this application. However, it is important to note that the vertical power generator wings or blades are free to oscillate back and forth in the spanwise direction on two guide rails in response to the air or water flow. In the configuration depicted in FIG. 1 the two horizontal wings are rigidly attached to the fuselage. The essence of the present patent application is the modification of the configuration depicted in FIG. 1. This modification is depicted in FIGS. 2 through 8.

FIG. 2 depicts the apparatus claimed in claim 1. A wing 1 is shown which is elastically or spring-mounted to a stationary body 3 in such a way that the wing can be excited into a finite-amplitude flapping oscillation about the body 3 by a control surface 7 mounted on the wing 1. The wing 1 is shown in an upward deflected position. The apparatus shown in FIG. 2 is exposed to a wind or water stream in a direction aligned with the body 3 by means of a vertical tail 4 attached at the rear of the body 3. An elastic connector piece 6 connects the wing 1 to the body 3 enabling the wing 1 to be excited into a flapping motion in response to the oscillation of the control surface 7.

FIG. 3 depicts the apparatus claimed in claim 1. This time the wing 1 is shown in a downward deflected position. It is the essence of the new disclosure that the flapping oscillation of the wing 1 exposes the power generator wing 2 to a gravity component so that the power generator wing's oscillation is being enhanced.

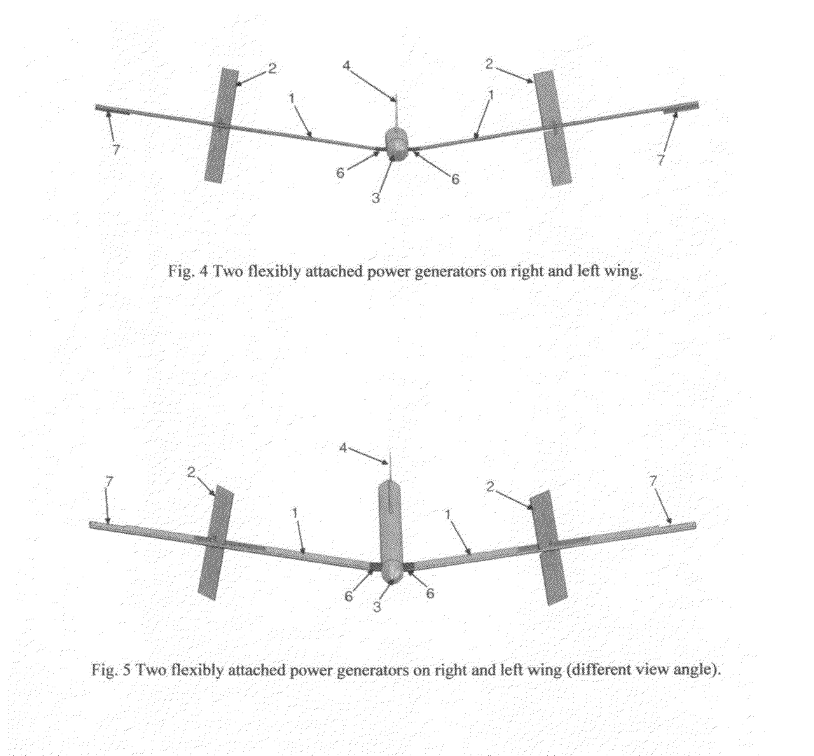

FIGS. 4 and 5 depict the apparatus claimed in claim 2. Both a right and a left wing 1 are elastically attached to the stationary body by means of the elastic connector piece 6 so that both wings 1 are flapping in a bird-like manner about the stationary body 3 that may be attached at the top of a structure. The two wings 1 are shown in the upward deflected position.

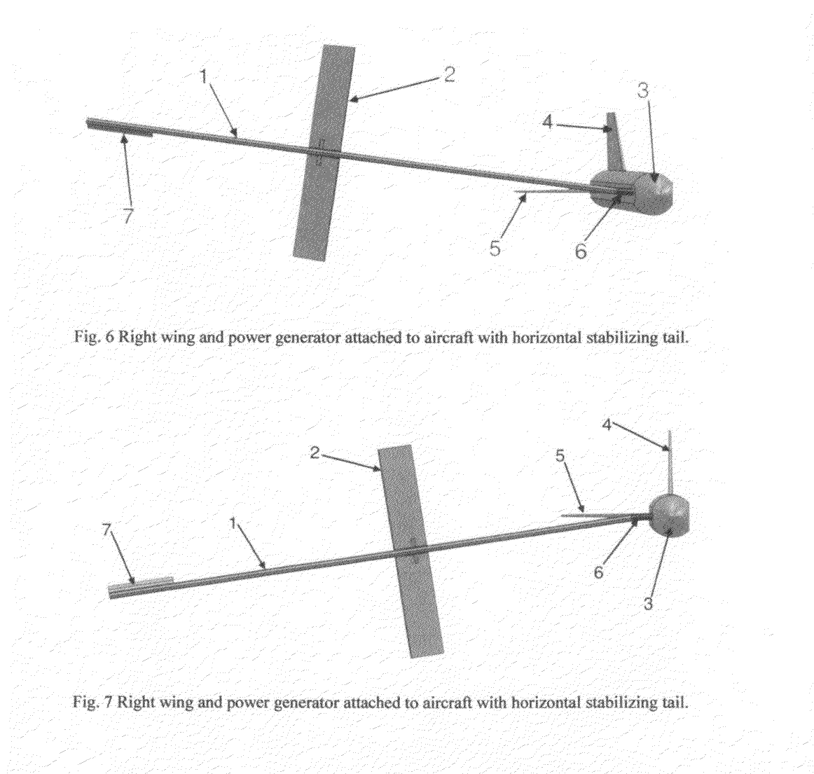

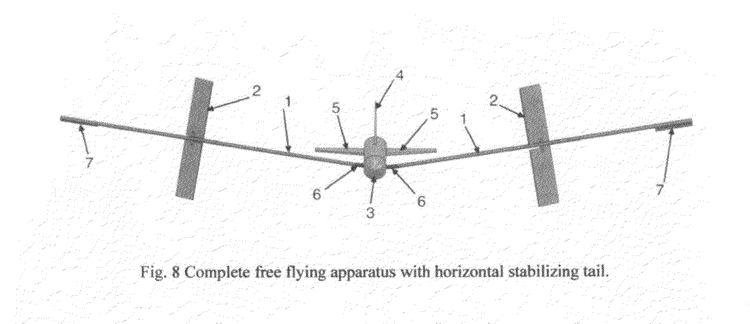

FIGS. 6, 7 and 8 depict the apparatus claimed in claim 3. FIGS. 6 and 7 depict the right wing 1 of a free-flying apparatus that is tethered to the ground. The only difference with the apparatus depicted in FIGS. 4 and 5 is the addition of a horizontal tail 5 in order to stabilize the apparatus in free flight. FIG. 8 depicts the complete free-flying apparatus.

The elastic connector piece 6 is to be understood as being representative of any mechanism, such as a torsion spring or any other spring-like device, that allows the wing to be excited into a finite-amplitude flapping oscillation.

Furthermore, it is to be understood that the control surface 7 is representative for any excitation mechanism capable of exciting the wing into a finite-amplitude flapping oscillation. Furthermore, it is to be understood that the design, manufacturing and installation of a control system to achieve the proper phasing is well within the state-of-the-art and therefore is not described in detail in this patent application.

### SUMMARY OF THE INVENTION

In summary, the essence of the proposed oscillating-foil power generator is the placement of the generator blades on spring-mounted or flexible wings so that these wings can be excited into roll or bending oscillations thus exposing the blades to a gravity component which enhances the blade oscillation if properly phased by wing-mounted control surfaces.

1. For use in generating electrical energy from air or water flows, apparatus comprising: a horizontal wing which is elastically or spring-mounted to a stationary body so that the wing can execute a flapping oscillation. A rail guide is mounted on the horizontal wing to which a vertical wing or blade is attached in such a way that the wing or blade can move along the rail guide. When the apparatus is exposed to a wind or water stream in the manner first disclosed and described in the patent application Ser. No. 12/266,553 dated Nov. 7, 2008 the vertical wing or blade starts to oscillate. This vertical wing or blade oscillation is enhanced by the flapping oscillation of the elastically or spring-mounted horizontal wing if the horizontal wing is activated into the flapping oscillation by means of a control surface or some other suitable excitation mechanism mounted on the horizontal wing. The control surface or other excitation mechanism is oscillated with such a phase angle that the vertical wing or blade is exposed to a gravity component which assists the wing or blade motion during the whole flapping cycle.

2. Apparatus as claimed in claim 1 but with two horizontal wings executing symmetric (bird-like) flapping oscillations about a stationary body which is aligned with the wind or water stream.

3. Apparatus as claimed in claims 1 and 2 but with the two wings attached to a fuselage/tail combination so that the whole apparatus is flying in the wind stream while being tethered to the ground.
